(19) United States
(12) Patent Application Publication
(10) Pub. No.: US 2012/0242076 A1
(43) Pub. Date: Sep. 27, 2012

(54) Coupling

(76) Inventors: Wayne Murray, Arcadia, CA (US); Daniel Murray, Monterey Park, CA (US)

(21) Appl. No.: 13/072,492

(22) Filed: Mar. 25, 2011

(51) Int. Cl. F16L 21/00; F16L 13/08

(52) U.S. Cl. 285/31; 285/289.1

(57) ABSTRACT

A coupling for pipes having an inside wall surface comprises first and second open ends, a bore, a side wall around the bore, and a longitudinal axis. At least the second open end is a male end and has at least one axially oriented protrusion protruding from the second open end for dislodging debris from the inside wall surface of the pipe when inserted therein.

### BACKGROUND

Couplings have many uses, including repairing pipe broken into segments. In such applications, typically a female-female coupling is used, where the coupling is slid over each segment on either side of the break, the coupling often being welded and/or soldered in place depending on the materials used. For vertically oriented pipes, such as those commonly found in commercial, household, and industrial installations, this can lead to leakage of welding or solder material.

Another problem when repairing a leak in pipes is there can often be debris, such as metal and salt deposits, on the inside surface of the pipe wall. This debris can interfere with a good fluid tight bond between the coupling and the pipe.

Accordingly, there is a need for a coupling to overcome problems associated with repairing a break in a pipe.

### SUMMARY

A coupling having features of the present invention is useful for fixing a break in a pipe. The coupling comprises first and second open ends, a bore, a side wall around the bore, and a longitudinal axis. At least the second open end is a male end, and has at least one axially oriented protrusion protruding therefrom for dislodging debris from an inside wall surface of the pipe when inserted therein. Preferably there are a plurality of the protrusions equally spaced around the second open end, where each protrusion extends at least ⅛ inch. Typically each protrusion has a distal end, where the distal end of the protrusion has a thickness less than the thickness of the coupling side wall. This can be achieved by beveling the protrusion.

Preferably the first open end is a female end, so that when using the coupling for repairing a broken metal pipe, the female end can face upwardly to trap solder without leakage. Preferably the female end and the male end are sized for coupling to pipe of the same diameter. Also preferably the coupling has lands on the outer surface adapted for gripping by a wrench, and for the same purpose, also can include knurling on the outer surface.

### DRAWINGS

These and other features, aspects, and advantages of the present invention will become better understood with regard to the following description, appended claims, and accompanying drawings where:

FIG. 1 is perspective view of a coupling having features of the present invention;

FIG. 2 is a longitudinal sectional view of the coupling of FIG. 1 taken on line 2-2 in FIG. 1;

FIG. 3 is a blowup of the male end of the coupling of FIG. 1 in region 3 of FIG. 1 showing projections according to the present invention;

FIG. 4 is an exploded view showing the coupling of FIG. 1 being used for joining two segments of broken pipe; and

FIG. 5 is a partial longitudinal sectional view of the assembly shown in FIG. 4.

### DESCRIPTION

With reference to the drawings, a coupling 10 has features according to the present invention. The coupling 10 is useful for repairing a break 12 in a pipe 14, the pipe having opposed first 16A and second 16B segments. In a particular application of the present invention, the pipe 14 can be metallic and vertically oriented, as is typically found in bathroom fixtures.

The coupling 10 has a first segment 17 with a first open end 18 and a second segment 19 having a second open end 20, the first open end 18 and the second open end 20 being opposed to each other.

At least the second open end 20 is a male end, and preferably the first open end 18 is a female end. As the coupling 10 is used for repairing the break 12 in the pipe 14, the female end 18 and the male end 20 are both sized for coupling to pipe segments 16A and 16B having the same outer diameter and inner diameter. Stated another way, if the pipe 14 is ⅜ inch OD, the coupling 10 can be used for repairing the pipe 14 without the use of any adapters, shims, or the like.

The coupling also includes a bore 22 and a side wall 24 surrounding the bore 22. The coupling also has a longitudinal axis 26.

The coupling includes at least one, and preferably a plurality of axially oriented extending protrusions 28 protruding from the second open end 20. The protrusions 28 are useful for removing debris from the inside wall surface 30 of the pipe 14 to keep the debris from interfering with any weld formed, and also to avoid any fluid leakage. Preferably the corners of the protrusions 28 are square, i.e. not radiused, for effective cleaning.

The external surface of the male segment 19 can have a plurality of circumferential grooves 32, each groove being axially spaced apart from another groove. The grooves 32 can extend the entire length of the male segment 19. These grooves 32 are useful for collecting molten solder during a welding operation. The grooves can be very small, such as only about 1 micron in depth and spaced apart (center-to-center) from each other by about 2 microns.

The coupling 10 is designed so that the connection to the pipe segments 16A and 16B is by a slip fit.

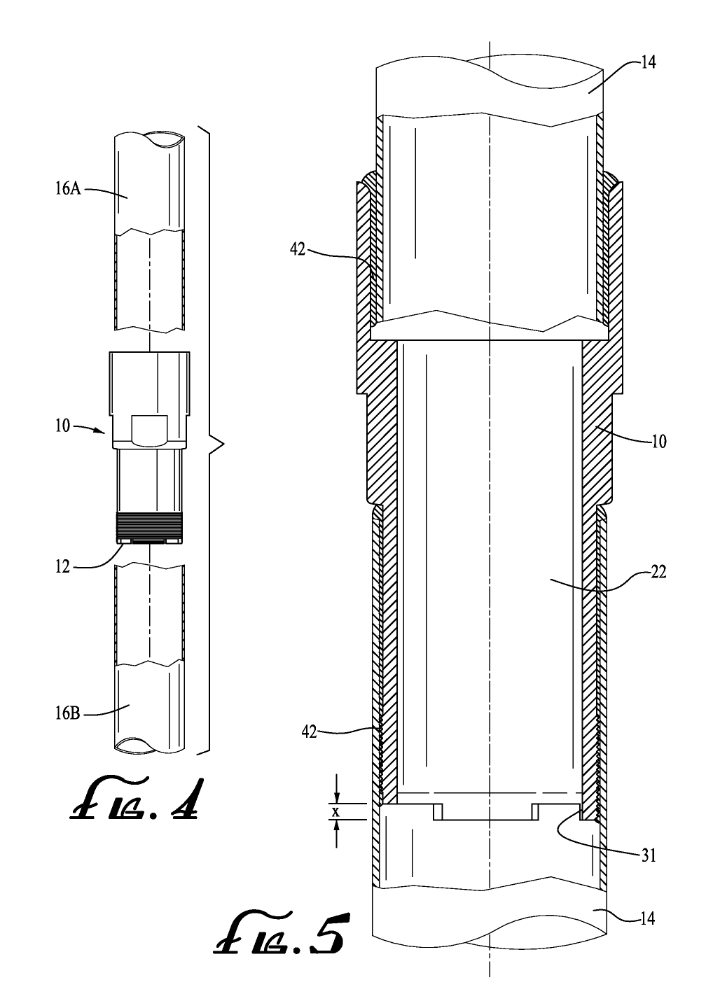

As best seen in FIG. 3, preferably the protrusions 28 are spaced apart from each other and are equally spaced around the male open end 20.

Each protrusion 28 has a distal 30 that needs to be suitably strong and sharp to scrape away debris, and preferably for this purpose the end 30 of the protrusions are beveled. Typically only the inside wall 31 of the coupling 10 is beveled i.e., the outside wall 32 of the coupling 10 is substantially constant in diameter, including at the protrusions. Thus in this preferred version, the distal end 30 of the protrusion 28 has a thickness less than the thickness of the coupling side wall 24.

The distance represented by “X” in FIG. 5 is the distance the protrusions 28 extend from the male end of the coupling. The distance X depends upon the size of the coupling. Typically the larger the coupling, the more the protrusions can extend. Preferably the protrusions 28 extend at least ⅛ inch, and can extend as much as ¼ inch.

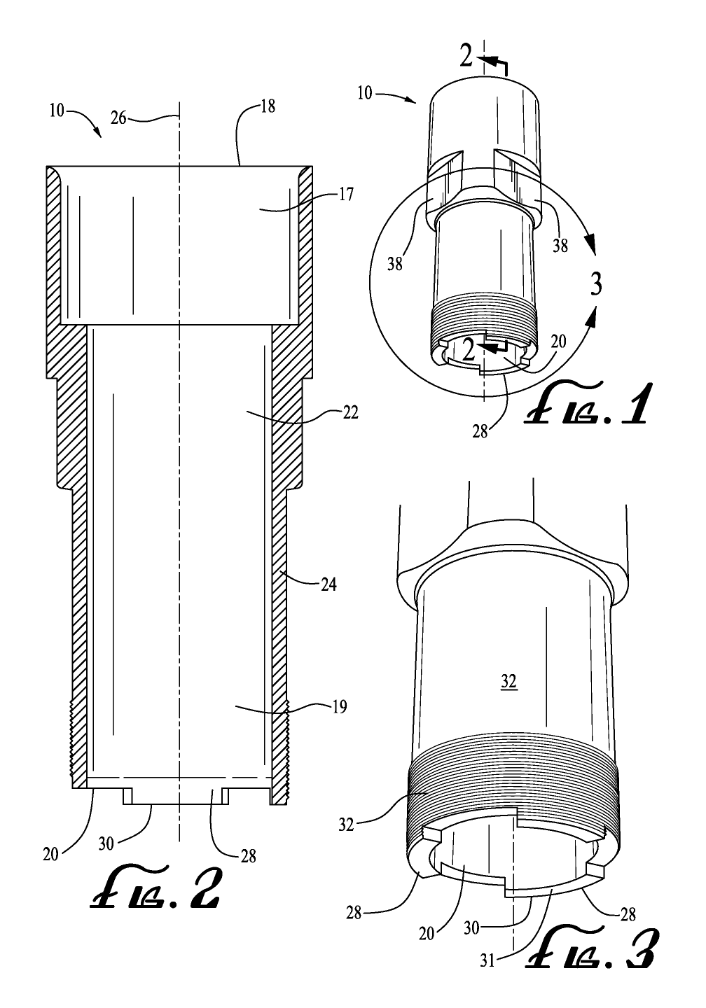

Optionally the coupling 10 has on its outside surface a plurality of circumferentially spaced apart lands 38 for gripping by a wrench. Knurling also can be provided for the same purpose. The lands typically are placed adjacent the outside surface of the first segment (female) 17 adjacent to the second segment 19 (male), as best shown in FIG. 1.

The coupling 10 can be formed of any material commonly used for pipes, including plastic such as polystyrene, polyvinyl chloride, and polyethylene, and metals such as stainless steel, copper, cast iron, brass, and bronze.

FIGS. 4 and 5 demonstrate how the coupling 10 can be used for repairing the break 12 in the vertically oriented pipe 14. In particular the coupling 10 is placed with the male end 20 facing downwardly and is slid into the second segment 16B of the pipe 14 while the female end 18 is slid over the first segment 16A of the pipe 14. Typically the coupling is positioned with the first segment 16A bottoming out in the female segment 17 and the amount the male segment 19 is slid into the second segment 16B a distance depending on the length of the break 12. The coupling, of course, is of greater length than the size of the break 12, but is sufficiently short to join the two pipe segments 16A and 16B together. As needed, either of both pipe segments can be cut to be make sure that the break is sufficiently large that the coupling 10 can be slid into place.

After the coupling is positioned, it is welded in place with or without soldering material 42, depending on the materials used. Alternatively, depending on the type of material used for the pipe 12 and coupling 10, an adhesive can be used.

### Example

An exemplary coupling according to the present invention is formed of copper with an internal diameter of about 1.1 inch and a length of about 3 inches where the male segment 19 is about 1.4 inches long and the female segment 17 is about 1.6 inches long. The wall thickness is 0.18 inch. There are three protrusions 28 spaced apart about a distance of about 0.54 inch (measured across an arc), each protrusion 28 extending about ⅛ inch and beveled as shown in FIG. 2. There are circumferential grooves 32, each of a depth of about 1 micron, the grooves being spaced apart from each other by about 2 microns.

Although the present invention has been described in consideration detail with reference to certain preferred versions thereof, other versions are possible. For example the coupling can be male-male where both ends have protrusions. Also, it can be a reducer coupling, where the segments are sized for different sized pipes. Therefore the scope of the following claims should be limited to the description preferred versions contained herein.

What is claimed is:

1. A coupling for pipes having an inside wall surface, the coupling comprising first and second open ends, a bore, a side wall around the bore, and a longitudinal axis, wherein at least the second open end is a male end, and further comprising at least one axially oriented protrusion protruding from the second open end for dislodging debris from the inside wall surface of the pipe when inserted therein.

2. The coupling of claim 1 wherein the protrusion extends at least ⅛ inch.

3. The coupling of claim 1 comprising a plurality of the protrusions.

4. The coupling of claim 1 comprising a plurality of protrusions equally spaced around the second open end.

5. The coupling of claim 1 wherein the protrusion has a distal end, and wherein the distal end of the protrusion has a thickness less than the thickness of the coupling side wall.

6. The coupling of claim 5 wherein the protrusion is beveled.

7. The coupling of claim 1 wherein the first end is a female end and the second end is a male end.

8. The coupling of claim 7 formed of metal adapted to be coupled to the pipe by welding with solder, and wherein the coupling side wall has an outer surface, and the outer surface of the male end has circumferential grooves for capturing solder.

9. The coupling of claim 1 wherein the female end and the male end are sized for coupling to pipe of the same outer diameter.

10. The coupling of claim 1 formed of metal adapted to be coupled to the pipe by welding with solder.

11. The coupling of claim 1 wherein the side wall has an outer surface, the coupling further comprising lands on the outer surface adapted for gripping by a wrench.

12. The coupling of claim 1 wherein the side wall has an outer surface, the coupling further comprising knurling on the outer surface adapted for gripping.

13. A metallic coupling adapted for fixing a break in a metal pipe by welding, the pipe having segments of the same outer diameter adjoining the break and having an inside wall surface, the coupling comprising:
a. a female open end and an opposed male open end, wherein the female end and the male end are sized for coupling to the segments of the metal pipe;
b. a bore;
c. a side wall around the bore;
d. a longitudinal axis; and
e. a plurality of axially oriented protrusions protruding from the second open end for dislodging debris from the inside wall surface of the pipe when inserted therein, wherein the protrusion has a distal end, and wherein the distal end of the protrusion has a thickness less than the thickness of the coupling side wall.

14. The coupling of claim 13 wherein the coupling side wall has an outer surface, and the outer surface of the male end has circumferential grooves for capturing solder.

15. The coupling of claim 13 comprising a plurality of protrusions equally spaced around the second open end.

16. A method for repairing a break in a pipe having a first segment and a second segment, comprising the steps of joining the first end of the coupling of claim 1 to the first segment and sliding the second end of the coupling into the second segment for dislodging debris present in the second segment.

17. The method of claim 16 wherein the pipe is substantially vertically oriented, the first open end of the coupling is a female end, and the coupling is oriented with the female end facing upwardly.
